(19) United States
(12) Patent Application Publication
(10) Pub. No.: US 2026/0322439 A1
(43) Pub. Date: Oct. 15, 2026

(54) BEAMFORMING SCHEME

(71) Applicant: Nokia Solutions and Networks Oy, Espoo (FI)

(72) Inventors: Hao LIU, Shanghai (CN); Stefan WESEMANN, Stuttgart (DE); Rana AHMED, Stuttgart (DE); Yan ZHAO, Shanghai (CN); Tao YANG, Shanghai (CN); Nuan SONG, Shanghai (CN)

(21) Appl. No.: 18/998,843

(22) PCT Filed: Jul. 28, 2022
(86) PCT No.: PCT/CN2022/108711

§ 371 Date: Jan. 27, 2025

(51) Int. Cl. H04B 7/06

(52) U.S. Cl. CPC H04B 7/0617

(57) ABSTRACT

Embodiments of the present disclosure relate to beamforming schemes. A network device comprises at least one processor; and at least one memory storing instructions. When executed by the at least one processor, the instructions cause the network device at least to divide a plurality of terminal devices into a plurality of groups based at least on channel characteristics associated with the plurality of terminal devices; determine, for a group of terminal devices among the plurality of groups, a beamforming weight associated with transmission of a downlink reference signal from the network device to the group of terminal devices; and transmit, to a terminal device of the group of terminal devices, the downlink reference signal precoded by the beamforming weight. In this way, the beamforming gain for transmission of downlink reference signals may be increased with controlled resource overhead.

### FIELD

Various example embodiments relate to the field of telecommunication and in particular, to a method, device, apparatus and computer readable storage medium for beamforming schemes.

### BACKGROUND

The 5G massive-Multiple Input Multiple Output (MIMO) system uses beamforming in order to maximize antenna gain for users. These schemes are essential for obtaining high gain with massive MIMO systems. One of the beamforming schemes used for massive MIMO refers to a scheme in which the UE specific Grid of beam (GOB) beams may be selected for different UEs. Another scheme is that a common GoB beam may be weighted for UEs within a cell. Efficient beamforming solutions are still needed in such deployment.

### SUMMARY

In general, example embodiments of the present disclosure provide a solution for performing beamforming for transmissions in a massive-MIMO system.

In a first aspect, there is provided a network device. The network device comprises at least one processor and at least one memory storing instructions. When executed by the at least one processor, the instructions cause the network device at least to divide a plurality of terminal devices into a plurality of groups based at least on channel characteristics associated with the plurality of terminal devices; determine, for a group of terminal devices among the plurality of groups, a beamforming weight associated with transmission of a downlink reference signal from the network device to the group of terminal devices; and transmit, to a terminal device of the group of terminal devices, the downlink reference signal precoded by the beamforming weight.

In a second aspect, there is provided a terminal device. The terminal device comprises at least one processor and at least one memory storing instructions. When executed by the at least one processor, the instructions cause the terminal device at least to receive, from a network device, configuration information indicating a group specific resource configuration for a downlink reference signal to be transmitted from the network device to a group of terminal devices including the terminal device; and receive, from the network device, the downlink reference signal precoded by a beamforming weight associated with transmission of the downlink reference signal to the group of terminal devices, based on the group specific resource configuration.

In a third aspect, there is provided a method. The method comprises dividing, at a network device, a plurality of terminal devices into a plurality of groups based at least on channel characteristics associated with the plurality of terminal devices; determining, for a group of terminal devices among the plurality of groups, a beamforming weight associated with transmission of a downlink reference signal from the network device to the group of terminal devices; and transmitting, to a terminal device of the group of terminal devices, the downlink reference signal precoded by the beamforming weight.

In a fourth aspect, there is provided a method. The method comprises receiving, at a terminal device from a network device, configuration information indicating a group specific resource configuration for a downlink reference signal to be transmitted from the network device to a group of terminal devices including the terminal device; and receiving, from the network device, the downlink reference signal precoded by a beamforming weight associated with transmission of the downlink reference signal to the group of terminal devices, based on the group specific resource configuration.

In a fifth aspect, there is provided an apparatus. The apparatus comprises means for dividing, at a network device, a plurality of terminal devices into a plurality of groups based at least on channel characteristics associated with the plurality of terminal devices; means for determining, for a group of terminal devices among the plurality of groups, a beamforming weight associated with transmission of a downlink reference signal from the network device to the group of terminal devices; and means for transmitting, to a terminal device of the group of terminal devices, the downlink reference signal precoded by the beamforming weight.

In a sixth aspect, there is provided an apparatus. The apparatus comprises means for receiving, at a terminal device from a network device, configuration information indicating a group specific resource configuration for a downlink reference signal to be transmitted from the network device to a group of terminal devices including the terminal device; and means for receiving, from the network device, the downlink reference signal precoded by a beamforming weight associated with transmission of the downlink reference signal to the group of terminal devices, based on the group specific resource configuration.

In a seventh aspect, there is provided a computer readable medium. The computer readable medium comprises program instructions that, when executed by an apparatus, cause the apparatus to perform at least the method according to any one of the above third or fourth aspect.

In an eighth aspect, there is provided a computer program. The computer program comprises instructions. When executed by an apparatus, the instructions cause the apparatus at least to divide a plurality of terminal devices into a plurality of groups based at least on channel characteristics associated with the plurality of terminal devices; determine, for a group of terminal devices among the plurality of groups, a beamforming weight associated with transmission of a downlink reference signal from the network device to the group of terminal devices; and transmit, to a terminal device of the group of terminal devices, the downlink reference signal precoded by the beamforming weigh.

In a ninth aspect, there is provided a computer program. The computer program comprises instructions. When executed by an apparatus, the instructions cause the apparatus at least to receive, from a network device, configuration information indicating a group specific resource configuration for a downlink reference signal to be transmitted from the network device to a group of terminal devices including the terminal device; and receive, from the network device, the downlink reference signal precoded by a beamforming weight associated with transmission of the downlink reference signal to the group of terminal devices, based on the group specific resource configuration.

In a tenth aspect, there is provided a network device. The network device comprises grouping circuitry configured to divide a plurality of terminal devices into a plurality of groups based at least on channel characteristics associated with the plurality of terminal devices; determining circuitry configured to determine, for a group of terminal devices among the plurality of groups, a beamforming weight associated with transmission of a downlink reference signal from the network device to the group of terminal devices; and transmitting circuitry configured to transmit, to a terminal device of the group of terminal devices, the downlink reference signal precoded by the beamforming weight.

In an eleventh aspect, there is provided a terminal device. The terminal device comprises configuration receiving circuitry configured to receive, from a network device, configuration information indicating a group specific resource configuration for a downlink reference signal to be transmitted from the network device to a group of terminal devices including the terminal device; and signal receiving circuitry configured to receive, from the network device, the downlink reference signal precoded by a beamforming weight associated with transmission of the downlink reference signal to the group of terminal devices, based on the group specific resource configuration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a signaling flow for communications according to some embodiments of the present disclosure;

FIG. 3 illustrates an example of port arrangements in an antenna array with which some example embodiments of the present disclosure may be applied;

FIG. 4 illustrates an example of a CSI-RS resource configuration with which some example embodiments of the present disclosure may be applied;

FIG. 5 illustrates an example implementation of a process for communication according to embodiments of the present disclosure;

FIGS. 6A and 6B illustrate spectrum efficient comparison for embodiments of the present disclosure and related schemes;

FIG. 7 illustrates a flowchart of a method implemented at a network device according to some embodiments of the present disclosure;

FIG. 8 illustrates a flowchart of a method implemented at a terminal device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Massive MIMO (mMIMO) and beamforming are widely used in the telecom industry. Terms “beamforming” and “mMIMO” are sometimes used interchangeably. In general, beamforming uses multiple antennas to control the direction of a wave-front by appropriately weighting the magnitude and phase of individual antenna signals in an array of multiple antennas. The most commonly seen definition is that mMIMO is a system where the number of antennas exceeds the number of users. The coverage is beam-based in 5G, not cell based. There is no cell-level reference channel from where the coverage of the cell could be measured. Instead, each cell has one or multiple synchronization signal and physical broadcast channel block (SSB) beams. SSB beams are static, or semi-static, always pointing to the same direction. They form a grid of beams covering the whole cell area. The user equipment (UE) searches for and measures the beams, maintaining a set of candidate beams. The candidate set of beams may contain beams from multiple cells. With 5G millimeter wave (mmWave) enabling directional communication with a larger number of antenna elements and providing an additional beamforming gain, efficient management of beams—where UE and gNB regularly identify the optimal beams to work on at any given point of time—has become crucial.

As mentioned above, massive-MIMO technology is one of the important solutions in obtaining high gain for 5G New Radio (NR) system. Ideally, the beamforming schemes should be such that high system performance (e.g., spectral efficiency) is obtained without excessive implementation complexity. The performance of the beamforming scheme depends on the used algorithm as well as on the type and amount of information required by said algorithm. Typically in 5G, downlink (DL) CSI-RS resources are configured for the terminal devices and a CSI RS may be transmitted to the terminal devices using the CSI-RS resource for measuring DL channel state and obtaining the corresponding CSI feedback including RI/PMI/CQI. Proper GoB beams are weighted over CSI-RS resources to achieve beamforming gain and reasonable CSI-RS coverage.

Conventionally, if GoB beams are selected for different terminal devices, CSI-RS resources can be specifically configured for different terminal devices by weighting the selected GoB beams respectively, and thus UE specific CSI-RS achieves better CSI measurement and feedback quality. However, CSI-RS overhead may become large with the increased number of active terminal devices. On the other hand, if cell specific CSI-RS resources are configured common to different terminal devices within a cell, the common GoB beams are weighted over the cell specific resources. Although CSI-RS overhead is greatly reduced, the accuracy of CSI feedback may be affected due to limited BF gain. How to effectively increase the accuracy of CSI measurement and reducing the CSI-RS resource overhead may be a great challenge to massive MIMO systems.

According to embodiments of the present disclosure, there is provided a solution for beamforming schemes in transmission for a massive-MIMO system. Principle and embodiments of the present disclosure will be described in detail below with reference to the accompanying drawings. However, it is to be noted that these embodiments are given to enable the skilled in the art to implement the solution as proposed herein and not intended to limit scope of the present application in any way.

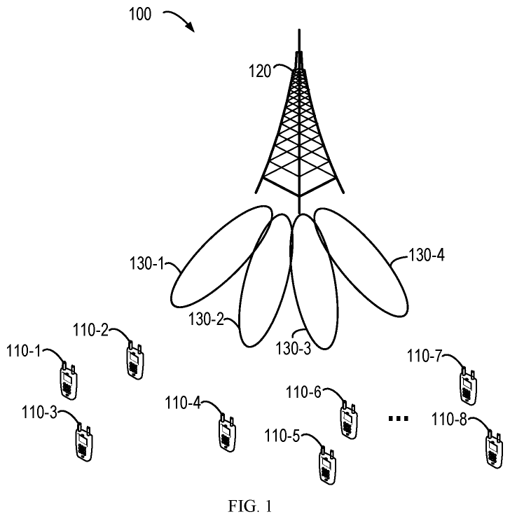

Reference is first made to FIG. 1, which illustrates an example communication system 100 in which embodiments of the present disclosure may be implemented. The system 100, which is a part of a communication network, comprises a plurality of terminal devices, such as terminal devices 110-1, 110-2, 110-3, . . . , 110-8, which can be collectively referred to as “terminal device(s) 110.” The number of the terminal devices can be any suitable integer number.

The communication system 100 further comprises a network device 120. In the communication system 100, the network device 120 and the terminal devices 110 can communicate data and control information to each other as long as the terminal devices are located within the corresponding cell. The network device 120 may have a plurality of beams such as beams 130-1, 130-2, 130-3 and 130-4 and the each terminal device may have at least one beam (not shown). An effective channel (or called as a sub-channel in this case) may be formed between antennas precoded by one of beams 130-1, 130-2, 130-3 and 130-4 of the network device and antennas of the terminal devices. The network device 120 may transmit information to the terminal device 110 or receive information from the terminal device 110 via one or more of the beams 130-1, 130-2, 130-3 and 130-4.

In communication systems, “UL” refers to a communication link in a direction from a terminal device to a network device, and “DL” refers to a communication link in a direction from the network device to the terminal device.

It is to be understood that the number of beams, network devices and terminal devices is given only for the purpose of illustration without suggesting any limitations. The system 100 may include any suitable number of network devices and/or terminal devices and/or beams adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

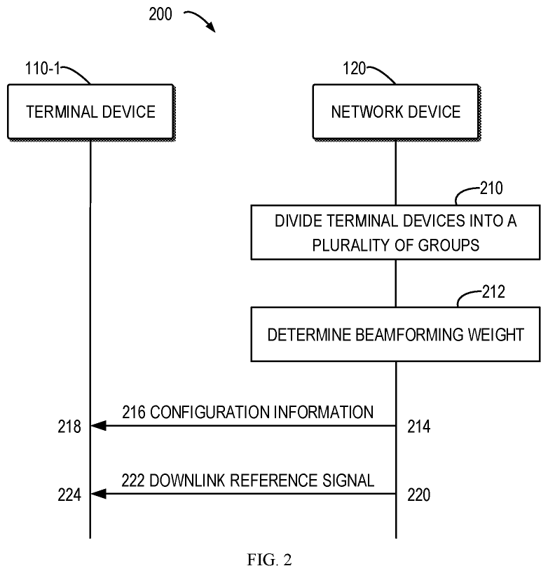

Embodiments of the present disclosure will be described in detail below. Reference is now made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1.

In the process 200, the network device 120 divides 210 a plurality of terminal devices into a plurality of groups based at least on channel characteristics associated with the plurality of terminal devices. The plurality of terminal devices may comprise the terminal devices 110-1, 110-2, 110-3, . . . , and 110-8 that have established a connection with the network device 120 and thus are located within the corresponding cell of the network device 120. In some embodiments, the number of divided groups may be preconfigured or determined by the network device 120 and may be equal to or less than the number of CSI-RS resources configured for the cell. For example, four CSI-RS resources may be configured for the cell and the plurality of terminal devices may be divided into four groups. Group A may comprise the terminal devices 110-1, 110-2 and 110-3, Group B may comprise the terminal device 110-4, Group C may comprise the terminal devices 110-5 and 110-6, and Group D may comprise the terminal devices 110-7 and 110-8.

The network device 120 determines 212, for a group of terminal devices among the plurality of groups, a beamforming weight associated with transmission of a downlink reference signal from the network device to the group of terminal devices. For example, the network device 120 may determine a beamforming weight associated with transmission of a downlink reference signal from the network device 120 to the Group A comprising the terminal devices 110-1, 110-2 and 110-3. The network device 120 transmits 220 a downlink reference signal 222 precoded by the determined beamforming weight to the terminal device 110-1. The terminal device 110-1 receives 224 the downlink reference signal 222 precoded by the determined beamforming weight. In this way, the beamforming gain for transmission of downlink reference signals may be increased without increasing resource overhead.

In some embodiments, the network device 120 may transmit 214 configuration information 216 to the terminal device 110-1. The configuration information 216 indicates a group specific resource configuration for a downlink reference signal to be transmitted from the network device 120 to the group of terminal devices. The terminal device 110-1 may receive 218 the configuration information 216. In this way, the terminal device may only measure a specific reference signal instead of multiple reference signals, which reduces the implementation complexity of the terminal device.

In some embodiments, the network device 120 may transmit the downlink reference signal 222 precoded by the determined beamforming weight based on the group specific resource configuration. The terminal device 110-1 may receive 224 the downlink reference signal based on the group specific resource configuration. In this way, the DL channel measurement accuracy may be increased.

In some embodiments, the network device 120 may transmit the configuration information 216 via at least one of a radio resource control (RRC) signaling, a medium access control (MAC) control element (CE), or downlink control information (DCI). In this way, the control of implementation complexity of the terminal device and the improvement of DL channel measurement accuracy may be well adapted based on actual needs.

In some embodiments, in order to divide the plurality of terminal devices into a plurality of groups, the network device 120 may first determine respective base terminal devices for the plurality of groups based on the channel characteristics associated with the plurality of terminal devices. For example, the network device 120 may determine terminal devices 110-1, 110-4, 110-5 and 110-8 as base terminal devices for the four groups respectively. In general, the allocating of the remaining terminal devices can be performed in various manners. For example, the network device 120 may allocating a terminal device among the plurality of terminal devices other than the base terminal devices into one of the plurality of groups based on similarities between the channel characteristic associated with the terminal device and the channel characteristic associated with each of the base terminal devices. For example, the network device 120 may allocate each of the remaining terminal devices 110-2, 110-3, 110-6 and 110-7 into one of the plurality of groups based on the similarities between the channel characteristic associated with the remaining terminal device and the channel characteristic associated with each of the base terminal devices 110-1, 110-4, 110-5 and 110-8. As another example, the network device 120 may allocating a remaining terminal device among the plurality of terminal devices other than the base terminal devices into one of the plurality of groups based on averaged similarities between the channel characteristic associated with the remaining terminal device and the channel characteristics associated with the allocated terminal devices in each group. In this way, the terminal devices may be grouped based on similarities of the channel characteristic, thus facilitating the determination of specific beamforming weight for each group.

In some embodiments, in order to determine the base terminal devices, the network device 120 may determine, for the plurality of terminal devices, respective channel representations of the channel characteristics associated with the plurality of terminal devices. The network device 120 may determine channel similarities between any two of the plurality of terminal devices based on the channel representations and determine, among the plurality of terminal devices, a first terminal device and a second terminal device having a least channel similarity among the channel similarities. The network device 120 may determine the first terminal device and the second terminal device as a base terminal device for a first group and a base terminal device for a second group among the plurality of groups, respectively. For example, the network device 120 may determine the terminal device 110-1 and the terminal device 110-8 as base terminal devices for Group A and Group D, respectively. In this way, terminal device grouping may be achieved based on channel characteristic similarities.

In some embodiments, the plurality of terminal devices may need to be divided into more than two groups. There may be various manners for the network device 120 to determine the base terminal devices for the remaining groups. For example, the network device 120 may determine, among the plurality of terminal devices other than the first and second terminal devices, a third terminal device and a fourth terminal device having a least channel similarity among the channel similarities and then determine the third terminal device and the fourth terminal device as a base terminal device for a third group and a base terminal device for a fourth group among the plurality of groups, respectively. In other words, the network device 120 may determine the base terminal devices for the remaining groups in a similar way as determining base terminal devices for the first and second groups. In this way, the base terminal devices may be easily determined with less computation complexity.

As another example, the network device 120 may determine, based on the channel representations, respective maximum channel similarities for terminal devices among the plurality of terminal devices other than the first and second terminal devices. The maximum channel similarity for the respective terminal device is a greater one of a first channel similarity between the respective terminal device and the first terminal device and a second channel similarity between the respective terminal device and the second terminal device. For example, the network device 120 may determine that the remaining terminal device 110-2 has a larger channel similarity with the determined base terminal device 110-1 than with the determined base terminal device 110-8 and thus determine the maximum channel similarity for the terminal device 110-2 to be its channel similarity with the determined base terminal device 110-1. The network device 120 may then determine, among the terminal devices other than the first and second terminal devices, a third terminal device having a minimum one among the maximum channel similarities and determine the third terminal device as a base terminal device for a third group among the plurality of groups. In this way, the base terminal devices with less channel characteristic similarities there between may be well determined.

In some embodiments, in order to allocate a remaining terminal device into one of the plurality of groups, the network device 120 may determine, among the base terminal devices, a base terminal device having a maximum channel similarity from the terminal device and allocate the terminal device to a group including the determined base terminal device among the plurality of groups. For example, the network device 120 may determine that the channel characteristic associated with the terminal device 110-2 has the largest similarity with the channel characteristic associated with the base terminal device 110-1. The terminal device 110-2 may thus be allocated to the Group A. The same allocation operation may be performed for the remaining terminal devices 110-3, 110-6 and 110-7. In this way, grouping of terminal devices may be well achieved.

There may be various manners for the network device 120 to determine the channel representation of the channel characteristic associated with each of the plurality of terminal device. For example, the network device 120 may receive an uplink reference signal from a terminal device among the plurality of terminal devices and determine an uplink channel characteristic associated with the terminal device based on the received uplink reference signal. The network device 120 may determine the channel representation associated with the terminal device based on the uplink channel characteristic. In this way, based on (partial) channel reciprocity, UL channel characteristic may be utilized for grouping of terminal devices.

As another example, the network device 120 may receive a respective channel state information report from the terminal device and determine the respective channel representation based on the channel state information report. In this way, relatively accurate downlink channel characteristic may be determined, especially for Frequency-division Duplex (FDD) based systems.

There may be various manners for the network device 120 to determine the beamforming weight associated with transmission from the network device to a group of terminal devices. For example, the network device 120 may receive a plurality of respective uplink reference signal from the plurality of terminal devices and determine a plurality of uplink channel characteristics associated with the plurality of terminal devices based on the received uplink reference signals. The network device 120 may determine a sum uplink channel characteristic based on the plurality of uplink channel characteristics associated with the group of terminal devices and determine the beamforming weight based on the sum uplink channel characteristic. In this way, the downlink channel characteristic may be easily determined based on uplink channel characteristic exploiting channel reciprocity.

There may be various manners for the network device 120 to determine the beamforming weight based on the sum uplink channel characteristic of the group. For example, the network device 120 may determine a dominant eigenvector of the sum uplink channel characteristic as the beamforming weight. In this way, optimal beamforming weight for each group may be determined.

As another example, the network device 120 may determine a GoB beam weight as the beamforming weight based on the sum uplink channel characteristic and predefined candidate GoB beams of the antenna array. In this way, beamforming weight for each group may be obtained easily.

In some embodiments, the uplink channel characteristic associated with a terminal device among the plurality of terminal devices may be a covariance matrix for the terminal device averaged over subpanels and polarizations of an antenna array of the network device. In some embodiments, the uplink channel characteristic associated with a terminal device among the plurality of terminal devices may be a covariance matrix for the terminal device averaged over polarizations of an antenna array of the network device. In this way, an uplink channel characteristic associated with a terminal device may be obtained in massive MIMO systems.

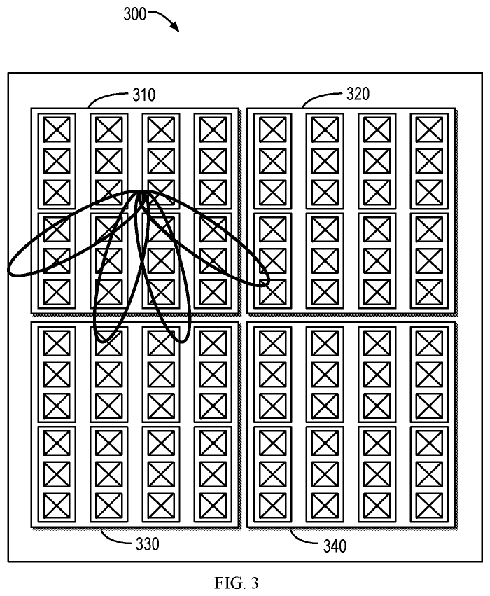

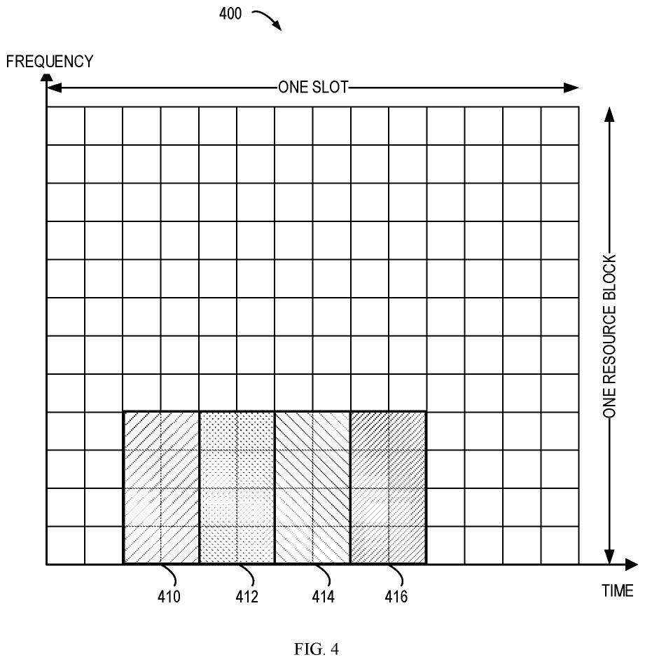

To better understand the CSI-RS configuration of massive MIMO systems in which some example embodiments of the present disclosure may be applied, reference is now made to FIGS. 3 to 5. FIG. 3 illustrates an example of port arrangements in an antenna array 300 with which some example embodiments of the present disclosure may be applied. FIG. 4 illustrates an example of a CSI-RS resource configuration 400 with which some example embodiments of the present disclosure may be applied. Only for the purpose of discussion, FIGS. 3 and 4 will be described with reference to FIG. 1. The antenna array 300 may be a part of the network device 120.

As shown in FIG. 3, the antenna array 300 is split into four subpanels 310, 320, 330 and 340. Each CSI-RS resource thus has 8 ports, each corresponding to one of the four subpanels and one of the two polarization directions. Only the four beams from the first subpanel 310 on one polarization direction are shown in FIG. 3. As shown in FIG. 4, four CSI-RS resources 410, 412, 414 and 416 may be configured for transmission of CSI-RS from the network device 120 to the terminal devices 110-1 to 110-8. The four CSI-RS resources may employ different GoB beams respectively to guarantee certain sector coverage. For example, the four beams from the first subpanel 310 may be associated with the four CSI-RS resources 410, 412, 414 and 416, respectively. Hereinafter, an example implementation of the solution will be described with reference to the antenna array 300 and the CSI-RS resource configuration 400, but it is to be noted that it is only an example scenario and the present disclosure is not limited thereto. For example, the concept of the present disclosure may be applied to an antenna array with different port arrangements and to an arbitrary number of CSI-RS resources.

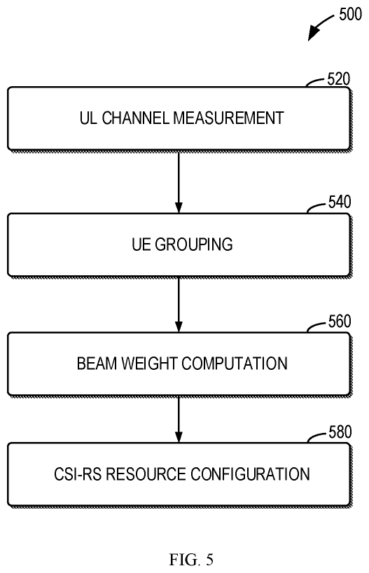

FIG. 5 illustrates an example implementation of a process 500 for communication according to embodiments of the present disclosure. It is noted that the process 500 can be considered as a more specific example of the process 200 of FIG. 2 applied into a massive MIMO system. Only for the purpose of discussion, FIG. 5 will be described with reference to FIGS. 1 and 3-4.

At block 520, each of the plurality of terminal devices 110-1 to 110-8 may transmit UL sounding reference signal (SRS) signals to the network device 120 for respective UL channel measurements. The network device 120 may measure the UL SRS signals from different active terminal devices within its serving coverage, and acquire respective UL channel characteristics (e.g., channel matrices or channel covariance matrices) of the terminal devices.

At block 540, the network device 120 may construct proper groups according to similarities in the measured UL channel characteristics from different terminal devices. In some embodiments, the network device 120 may set N_{gr} groups and divide the active terminal devices into the N_{gr} groups according to the measured UL channels. N_{gr} is equal to or less than the number of configured CSI-RS resources. The number of configured CSI-RS resources as shown in FIG. 4 is four. In this embodiment, N_{gr} may be set to be 4. Each group contains one or more terminal devices having similar channel characteristics. The channel similarity may be represented in various metric manners, such as channel correlation. Terminal devices with high channel correlation properties are allocated to a same group, while terminal devices with low channel correlation values are divided into different groups. It is to be noted that this grouping criterion is very different to the one used for data (PDSCH/PUSCH) transmissions, where highly correlated terminal devices are typically assigned to different scheduling groups in the same time and frequency resources. In the following description, the terms “channel correlation” and “channel similarity” may be used interchangeably.

In order to calculate the channel correlation between terminal devices for terminal device grouping, the network device first determines a proper channel representation for each active terminal device, such as dominant eigenvector derived from UL channel covariance matrix, or an optimal GoB beam selected according to UL channel measurement, or even UL CSI reports (e.g., Type I CSI, or Type II CSI) from the UE. As an example, the selected GoB beams may be utilized as the channel representation for the grouping of terminal devices in an example implementation according to some example embodiments of the present disclosure. Candidate GoB beams can be generated based on split-panel geometry for each polarization as shown in FIG. 3, or full-panel array configuration without any division in a polarization. As an example, the split-panel geometry as shown in FIG. 3 is employed as an example to demonstrate channel similarity calculation according to some example embodiments of the present disclosure.

As shown in FIG. 3, the antenna array has Nₜ=2N₁N₂ transceiver (TRX) units, where N₁ and N₂ are the number of TRX units in horizontal and vertical dimension respectively for a polarization. The antenna array is split into Nₛₚ subpanels, each having Nₜ/2Nₛₚ TRX units for each polarization, including N_{sp,1} horizontal TRX units and N_{sp,2} vertical TRX units. Thus, Nₜ=2N_{SP}N_{sp,1}N_{sp,2}. For the geometry as shown in FIG. 3, Nₛₚ=4. GoB beams may be generated as oversampled DFT vectors based on split-panel geometry in FIG. 3. It is noted that the oversampled DFT vectors are provided as an example for purpose of illustration and other vector types are not precluded. For example, the horizontal oversampled DFT vectors w_{h,i}, i=1, . . . , O₁N_{sp,1}, have the size of N_{sp,1}×1, where O₁ is the oversampled rate in horizontal dimension. The vertical oversampled DFT vectors w_{v,j}, j=1, . . . , O₂N_{sp,2}, have the size of N_{sp,2}×1, where O₂ is the oversampled rate in vertical dimension. Then GoB beams wₖ are produced exploiting Kronecker product of horizontal and vertical vectors, such as wₖ=w_{h,i}w_{v,j}, O₁O₂N_{sp,1}N_{sp,2}, with the size of N_{sp,1}N_{sp,2}×1. The optimal GoB beam weight w_{o,u} may be determined for a terminal device u from the predefined GoB beams wₖ according to its UL channel variation as the follow equation (1):

$${w}_{o , u} = arg {max}_{{w}_{k} , k = 1 , … , {o}_{1} {o}_{2} {N}_{sp , 1} {N}_{sp , 2}} ( sum ( abs ( diag ( {W}_{k}^{H} {R}_{u} {W}_{k} ) ) ) ) \qquad ( 1 )$$

where

$${W}_{k} = [ \begin{matrix}{w}_{k} & & 0 \\ & ⋱ & \\ 0 & & {w}_{k}\end{matrix} ]$$

with the same GoB beam weight for all the Nₛₚ split-panels and both polarizations, and Rᵤ is the covariance matrix (e.g., covariance matrix averaged over both polarizations or full covariance matrix) for the terminal device u. When Rᵤ is a covariance matrix averaged over both polarizations, it has the dimension of

$$\frac{{N}_{t}}{2} \times \frac{{N}_{t}}{2}$$

and Wₖ has the dimension of

$$\frac{{N}_{t}}{2} \times {N}_{sp} .$$

When Rᵤ is a full covariance matrix, it has the dimension of Nₜ×Nₜ and Wₖ has the dimension of Nₜ×2Nₛₚ. It should be noted that the uplink channel characteristic Rᵤ for the terminal device u may be represented in other manners than the covariance matrix.

The network device 120 may perform the grouping of terminal devices by calculating and comparing the channel similarities of the optimal GoB beam weights of all the terminal devices. The network device 120 may first select a single terminal device (also referred to as a base terminal device) for each group so that each group contains at least a base terminal device. The network device 120 may then allocate the remaining terminal devices into different groups.

A grouping process may be described below in detail as an example, but other grouping algorithms are not precluded. First, the network device 120 may select two base terminal devices having the least channel similarity between any two terminal devices and allocate the two selected base terminal devices to different groups (e.g., Group A and Group D). For example, the two base terminal devices may be selected to be terminal devices 110-1 and 110-8 among the plurality of terminal devices 110-1 to 110-8 based on

$$arg {min}_{( i , j )} abs ( {w}_{o , i}^{H} {w}_{o , j} )$$

where i and j are index numbers of the terminal devices 110-1 to 110-8 to be grouped and w_{o,i} is the optimal GoB beam weight for a terminal device i determined by the network device 120 according to UL channel measurement. The network device 120 may then select the base terminal devices for the remaining Group B and Group C in various manners.

In a first alternative embodiment of UE grouping, the network device 120 may select another two base terminal devices having the least channel similarity among the remaining terminal devices other than the previously selected base terminal devices 110-1 and 110-8 based on

$$arg {min}_{( i , j )} abs ( {w}_{o , i}^{H} {w}_{o , j} )$$

where i and j are index numbers of the remaining terminal devices 110-2 to 110-7. The network device 120 may allocate the two newly selected base terminal devices to the remaining Group B and Group C.

In a second alternative embodiment of UE grouping, the network device 120 may select respective base terminal devices for the remaining groups based on argminᵢ

$$( {max}_{j} abs ( {w}_{o , i}^{H} {w}_{o , j} ) )$$

where i is an index number of any of the remaining terminal devices and j is the index number of any of the previously selected base terminal devices. When selecting base terminal device for Group B after determining base terminal devices for Group A and Group D, j may be selected out of base terminal devices 110-1 and 110-8 and base terminal device for Group B may be selected as e.g., terminal device 110-4. When selecting base terminal device for Group C after determining base terminal devices for Group A, Group B and Group D, j may be selected out of base terminal devices 110-1, 110-4 and 110-8 and base terminal device for Group C may be selected as e.g., terminal device 110-6.

The network device 120 may then search the optimal group index for each of the remaining terminal devices according to its channel similarity with the four selected base terminal devices. For example, the network device 120 may allocate each of the remaining terminal devices into the four groups based on

$$arg {max}_{j} abs ( {w}_{o , i}^{H} {w}_{o , j} )$$

where i is an index number of any of the remaining terminal devices 110-2, 110-3, 110-5 and 110-7 and j is the index number of any of the selected base terminal devices 110-1, 110-4, 110-6 and 110-8. Each group may contain one or more terminal devices.

At block 560, for each group, the network device 120 may create a CSI-RS resource precoded by a group specific beamforming weight calculated based on UL channel measurement from the terminal devices within the group. There may be various manners for the network device 120 to determine the beamforming weight for each group. For example, the beamforming weights may be eigenvectors derived from UL channel covariance matrix, or GoB beams selected according to UL channel measurement, or any other beamforming patterns.

In some embodiments, for each group, the network device 120 may determine an average channel covariance matrix over all subpanels and polarizations and terminal devices selected in the group, and then compute the dominant eigenvector of this average covariance matrix as the beamforming weight. The network device 120 may apply the beamforming weight to all subpanels and polarizations in transmission from the network device to a terminal device in the group.

In some embodiments, the candidate GoB beams wₖ (k=1, . . . , O₁O₂N_{sp,1}N_{sp,2}) are predefined based on split-panel geometry shown in FIG. 3. For each group g, the network device 120 may determine an optimal GoB beam weight w_{o,g} from the predefined GoB beams wₖ according to UL channel variations of all the terminal devices within the group as the follow equation (2):

$${w}_{o , g} = arg {max}_{{w}_{k} , k = 1 , … , {o}_{1} {o}_{2} {N}_{sp , 1} {N}_{sp , 2}} ( sum ( abs ( diag ( {W}_{k}^{H} {R}_{g} {W}_{k} ) ) ) )$$

where

$${W}_{k} = [ \begin{matrix}{w}_{k} & & 0 \\ & ⋱ & \\ 0 & & {w}_{k}\end{matrix} ]$$

with the same GoB beam weight for all the Nₛₚ split-panels and both polarizations, and

$${R}_{g} = {\sum }_{k} \frac{{R}_{g , k}}{‖ {R}_{g , k} ‖} ,$$

R_{g,k} is the covariance matrix (e.g., covariance matrix averaged over both polarizations or full covariance matrix) for the terminal device k within the group g. As another example, R_{g}=Σₖ R_{g,k}. When R_{g} is a covariance matrix averaged over both polarizations, it has the dimension of

$$\frac{{N}_{t}}{2} \times \frac{{N}_{t}}{2}$$

and Wₖ has the dimension of

$$\frac{{N}_{t}}{2} \times {N}_{sp} .$$

When R_{g} is a full covariance matrix, it has the dimension of Nₜ×Nₜ and Wₖ has the dimension of Nₜ×2Nₛₚ. It should be noted that the uplink channel characteristic R_{g,k} for the terminal device k may be represented in other manners than the covariance matrix.

For each group g, its associated CSI-RS resource utilizes a common GoB beam w_{o,g} in different subpanels and different polarizations. Each group has 2Nₛₚ CSI-RS ports weighted by the common GoB beam weight w_{o,g}. The GoB beam weight may be dynamically or semi-statically determined based on the channel variation of the terminal devices within the group. Each CSI-RS resource can employ a corresponding GoB beam weight. For example, the CSI-RS resource 410 may employ a corresponding GoB beam weight well adapted to channel variation of the terminal devices within the Group A. The CSI-RS resource 412 may employ a corresponding GoB beam weight well adapted to channel variation of the terminal device within the Group B. The CSI-RS resource 414 may employ a corresponding GoB beam weight well adapted to channel variation of the terminal devices within the Group C. The CSI-RS resource 416 may employ a corresponding GoB beam weight well adapted to channel variation of the terminal devices within the Group D.

At block 580, the network device 120 may indicate to a terminal device in a group the CSI-RS resource configuration messages over RRC, MAC-CE or DCI signaling and transmit the CSI-RS precoded based on the corresponding beam weight to the terminal device for DL channel measurement.

In a first alternative embodiment of resource configuration, the CSI-RS resource for the group which the terminal device belongs to may be indicated to the terminal device via DCI signaling. In some scenarios, the grouping may be frequently updated. The terminal devices in each group may vary over time and thus beamforming weight for each group may be dynamically determined. The terminal device may change from a first group to a second group. Based on the DCI signaling, the terminal device may only need to measure a single CSI-RS resource corresponding to the newly allocated group and report RI/PMI/CQI feedback for the indicated CSI-RS resource. In this way, the spectrum efficiency and the beamforming gain may be increased.

In a second alternative embodiment of resource configuration, the CSI-RS resource for the group which the terminal device belongs to may be indicated to the terminal device via RRC or MAC-CE signaling. In some scenarios, the grouping may be static or semi-static. The terminal devices in each group may vary less frequently over time. For example, the terminal device may be allocated to a first group and not changed for a long period. In some scenarios, the beamforming weight for each group may be dynamically determined. The terminal device may only need to measure a single CSI-RS resource corresponding to the allocated group and report RI/PMI/CQI feedback for the indicated CSI-RS resource. In this way, the spectrum efficiency may be increased with a low signaling overhead.

In a third alternative embodiment of resource configuration, all the CSI-RS resources (e.g., four CSI-RS resources 410, 412, 414 and 416 in FIG. 4) may be configured for transmission of CSI-RS from the network device 120 to each of the terminal devices 110-1 to 110-8 via RRC signaling. The terminal devices 110-1 to 110-8 may measure all the CSI-RS resources, select the optimal CSI-RS resource with, such as the largest receive power, and report its CSI-RS resource indicator (CRI). At the same time, the UE also reports RI/PMI/CQI feedback for the selected CSI-RS resource. In this way, the spectrum efficiency and the beamforming gain may be increased with a low signaling overhead.

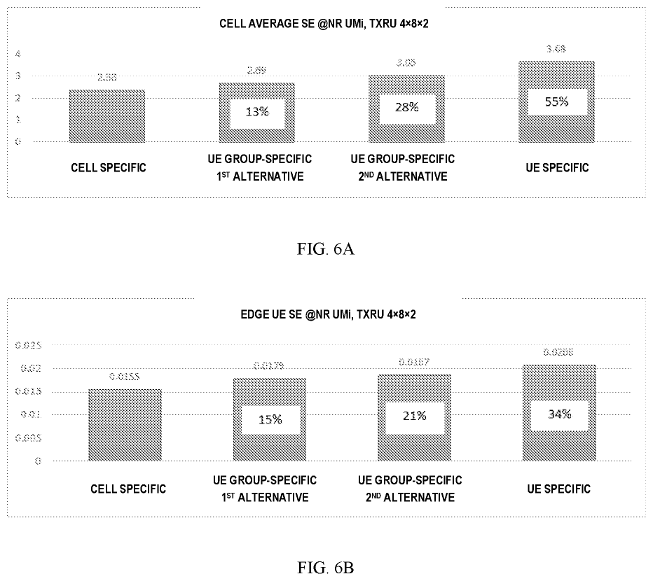

FIGS. 6A and 6B illustrate spectrum efficient comparison for embodiments of the present disclosure and related schemes. Specifically, FIG. 6A shows a cell spectrum efficient comparison for different CSI-RS schemes, and FIG. 6B shows an edge UE spectrum efficient comparison for different CSI-RS schemes. For performance evaluation of UE group specific CSI-RS scheme, the full buffer system level evaluations are carried out in NR Urban Micro (UMi) scenario with FDD deployment. The results are provided for 64 TRX units with (N₁, N₂)=(8, 4) in the horizontal and vertical dimension respectively. As shown in FIG. 3, the antenna array is split into Nₛₚ=4 subpanels with 2×2 deployment. The relevant simulation parameters are listed in Table 1.

TABLE 1
System level simulation assumptions

| Parameters | Values | Parameters | Values |
|---|---|---|---|
| Cell layout | NR-UMi: ISD- | Down Tilt | 100 degree |
| | 200 m, 7 sites | | (hori: 90) |
| | wraparound, 3 | | |
| | cells per site | | |
| | Average 10 UE | | |
| | per cell | | |
| Carrier | DL: 2150 MHz | Traffic | Full buffer |
| Freq. | UL: 1750 MHz | Model | |
| Bandwidth | 20 MHz (NR) | Channel | sub-6 GHz in 3GPP |
| | | Model | TR 38.901 |
| SCS | 30 KHz (NR) | Handover | 1 dB |
| | | Margin | |
| UE | UE-based RSRP | CSI/CQI | 1 ms delay for SRS, |
| association | | latency | 6 ms scheduling |
| | | | delay for UE |
| | | | feedback, |
| | | | update period 5 |
| | | | ms for SRS and |
| | | | CSI-RS |
| BS TX | 192 AEs | UE RX | 2 AEs |
| antenna | (12 × 8 × 2) | antenna | (1 × 1 × 2) |
| BS antenna | element spacing: | Scheduling | PF (Proportional |
| array | 0.5λ in horizontal | | Fair) |
| | and 0.7λ in | | |
| | vertical | | |
| BS TRX | 64 ports | SU-MIMO/MU- | Dynamic switching, |
| | (4 × 8 × 2) | MIMO | Zero Forcing |
| | | | precoding |

Cell specific CSI-RS scheme is used as performance reference. Cell specific CSI-RS is configured with 4 CSI-RS resources common for all the UEs within a cell. GoB beams in the cell specific CSI-RS scheme are generated based on split-panel geometry in FIG. 3. For example, in vertical dimension, a DFT vector vᵥ is generated according to the downtilt angle with the dimension of N₂/2/1. In horizontal dimension, N₁/2 orthogonal DFT vectors v_{h,i} (i=1, . . . , N₁/2) are generated with the size of N₁/2×1. GoB beams vᵢ are produced exploiting Kronecker product of horizontal and vertical vectors, such as vᵢ=v_{h,i}⊗vᵥ, i=1, . . . , N₁/2, with the size of N₁N₂/4×1. A CSI-RS resource utilizes a common GoB beam vᵢ in different subpanels and different polarizations, and it has 8 CSI-RS ports weighted by the common GoB beam.

UE specific CSI-RS can be regarded as upper bound of system performance of different CSI-RS designs of embodiments of the present disclosure. UE specific CSI-RS use oversampled GoB beam pattern implemented in a similar way in embodiments of the present disclosure with only one terminal device in each group.

Two alternatives of UE grouping algorithm in block 540 are compared for UE group specific CSI-RS, in which frequent CSI-RS resource re-configuration through DCI (first alternative embodiment of resource configuration in block 580) is assumed. UE group specific CSI-RS use oversampled GoB beam pattern described in embodiments of the present disclosure. UE group specific CSI-RS has the same number of CSI-RS resources as the cell specific CSI-RS scheme with N_{gr}=4. Type I PMI is reported with the configuration of 2×2×2 pattern based on the measurement of beamformed CSI-RS resources. The simulation results are shown in Table 2 and FIGS. 6A and 6B.

TABLE 2
System level simulation results for different CSI-RS schemes

| | Cell average SE | 5% cell edge SE |
|---|---|---|
| CSI feedback scheme | (bps/Hz) | (bps/Hz) |
| Cell specific CSI-RS | 2.38 | 0.0155 |
| (baseline) | | |
| UE group specific CSI-RS | 2.69 (13%) | 0.0179 (15%) |
| (first alternative | | |
| of UE grouping) | | |
| UE group specific CSI-RS | 3.05 (28%) | 0.0187 (21%) |
| (second alternative | | |
| of UE grouping) | | |
| UE specific CSI-RS | 3.68 (55%) | 0.0208 (34%) |
| (Upper bound) | | |

As shown in Table 2 and FIGS. 6A and 6B, UE group specific CSI-RS scheme using dynamic split-panel beams outperforms baseline cell specific scheme by up to 21%-28% performance gain without extra CSI-RS overhead, and it can be regarded as an enhancement of the cell specific scheme. With the UE group specific CSI-RS scheme, group specific dynamic beamforming is supported with low CSI-RS resource overhead.

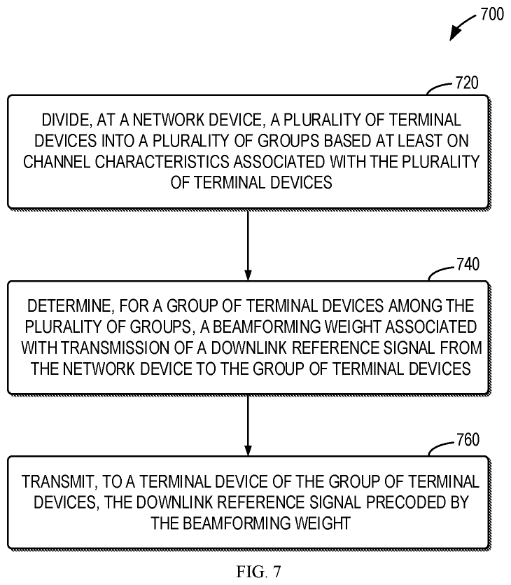

FIG. 7 shows a flowchart of an example method 700 implemented at a network device in accordance with some embodiments of the present disclosure. For the purpose of discussion, the method 700 will be described from the perspective of the network device 120 with reference to FIG. 1. With the method 700, the beamforming gain for transmission of downlink reference signals may be increased with controlled resource overhead.

At block 720, the network device 120 divides a plurality of terminal devices into a plurality of groups based at least on channel characteristics associated with the plurality of terminal devices. At block 740, the network device 120 determines, for a group of terminal devices among the plurality of groups, a beamforming weight associated with transmission of a downlink reference signal from the network device to the group of terminal devices. At block 760, the network device 120 transmits, to a terminal device of the group of terminal devices, the downlink reference signal precoded by the beamforming weight.

In some embodiments, for the plurality of groups, the network device 120 may determine respective base terminal devices based on the channel characteristics associated with the plurality of terminal devices. The network device 120 may allocate a terminal device among the plurality of terminal devices other than the base terminal devices into one of the plurality of groups based on similarities between the channel characteristic associated with the terminal device and the channel characteristic associated with each of the base terminal devices.

In some embodiments, for the plurality of terminal devices, the network device 120 may determine respective channel representations of the channel characteristics associated with the plurality of terminal devices. The network device 120 may determine channel similarities between any two of the plurality of terminal devices based on the channel representations. The network device 120 may determine, among the plurality of terminal devices, a first terminal device and a second terminal device having a least channel similarity among the channel similarities. The network device 120 may determine the first terminal device and the second terminal device as a base terminal device for a first group and a base terminal device for a second group among the plurality of groups, respectively.

In some embodiments, the network device 120 may determine, among the plurality of terminal devices other than the first and second terminal devices, a third terminal device and a fourth terminal device having a least channel similarity among the channel similarities. The network device 120 may determine the third terminal device and the fourth terminal device as a base terminal device for a third group and a base terminal device for a fourth group among the plurality of groups, respectively.

In some embodiments, the network device 120 may determine, based on the channel representations, respective maximum channel similarities for terminal devices among the plurality of terminal devices other than the first and second terminal devices. Each of the maximum channel similarities may be a greater one of a first channel similarity between a respective terminal device and the first terminal device and a second channel similarity between the respective terminal device and the second terminal device. The network device 120 may determine, among the terminal devices other than the first and second terminal devices, a third terminal device having a minimum one among the maximum channel similarities. The network device 120 may determine the third terminal device as a base terminal device for a third group among the plurality of groups.

In some embodiments, the network device 120 may determine, among the base terminal devices, a base terminal device having a maximum channel similarity from the terminal device. The network device 120 may allocate, among the plurality of groups, the terminal device to a group, including the determined base terminal device.

In some embodiments, the network device 120 may receive an uplink reference signal from a terminal device among the plurality of terminal devices. The network device 120 may determine, based on the received uplink reference signal, an uplink channel characteristic associated with the terminal device. The network device 120 may determine, based on the uplink channel characteristic, the channel representation associated with the terminal device.

In some embodiments, the network device 120 may receive, from the plurality of terminal devices, a plurality of respective channel state information reports. The network device 120 may determine the channel representations based on the plurality of channel state information reports.

In some embodiments, the network device 120 may receive, from the plurality of terminal devices, a plurality of respective uplink reference signals and determine, based on the plurality of uplink reference signals, a plurality of uplink channel characteristics associated with the plurality of terminal devices.

In some embodiments, the network device 120 may determine a sum uplink channel characteristic based on the plurality of uplink channel characteristics associated with the group of terminal devices. The network device 120 may determine the beamforming weight based on the sum uplink channel characteristic.

In some embodiments, the network device 120 may determine a dominant eigenvector of the sum uplink channel characteristic as the beamforming weight.

In some embodiments, the network device 120 may determine a GoB beam weight as the beamforming weight based on the sum uplink channel characteristic and predefined candidate GoB beams of the antenna array.

In some embodiments, the uplink channel characteristic associated with a terminal device among the plurality of terminal devices may be a covariance matrix for the terminal device averaged over subpanels and polarizations of an antenna array of the network device.

In some embodiments, the uplink channel characteristic associated with a terminal device among the plurality of terminal devices may be a covariance matrix for the terminal device averaged over polarizations of an antenna array of the network device.

In some embodiments, the network device 120 may transmit, to the terminal device of the group of terminal devices, configuration information indicating a group specific resource configuration for the downlink reference signal.

In some embodiments, the network device 120 may transmit the downlink reference signal precoded by the beamforming weight based on the group specific resource configuration.

In some embodiments, the network device 120 may transmit the configuration information via at least one of a radio resource control (RRC) signaling, a medium access control (MAC) control element (CE), or downlink control information (DCI).

In some embodiments, the network device 120 may transmit, to the terminal device of the group of terminal devices, the configuration information indicating at least the group specific resource configuration and a further group specific resource configuration.

In some embodiments, the network device 120 may transmit the downlink reference signal precoded by the beamforming weight based on the group specific resource configuration and transmit the downlink reference signal precoded by a further beamforming weight based on the further group specific resource configuration. The further beamforming weight may be associated with transmission of a downlink reference signal from the network device to a further group of terminal devices among the plurality of groups. The further group of terminal devices may be different from the group of terminal devices.

In some embodiments, the network device 120 may transmit the configuration information via a RRC signaling.

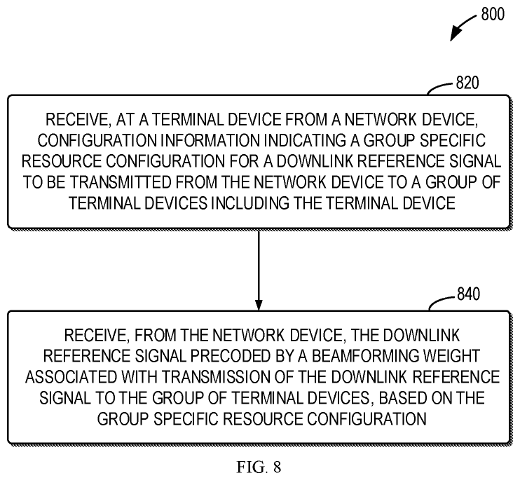

FIG. 8 shows a flowchart of an example method 800 implemented at a terminal device in accordance with some embodiments of the present disclosure. For the purpose of discussion, the method 800 will be described from the perspective of the terminal device 110-1 with reference to FIG. 1. With the method 800, the DL channel measurement accuracy may be increased with controlled resource overhead.

At block 820, the terminal device 110-1 receives, from a network device 120, configuration information indicating a group specific resource configuration for a downlink reference signal to be transmitted from the network device to a group of terminal devices including the terminal device. At block 840, the terminal device 110-1 receives, from the network device, the downlink reference signal precoded by a beamforming weight associated with transmission of the downlink reference signal to the group of terminal devices, based on the group specific resource configuration.

In some embodiments, the terminal device 110-1 may receive the configuration information via at least one of a radio resource control (RRC) signaling, a medium access control (MAC) control element (CE), or downlink control information (DCI).

In some embodiments, the terminal device 110-1 may receive the configuration information indicating at least the group specific resource configuration and a further group specific resource configuration different from the group specific resource configuration.

In some embodiments, the terminal device 110-1 may receive, from the network device, the downlink reference signal precoded by a further beamforming weight associated with transmission of the downlink reference signal to a further group of terminal devices different from the group of terminal devices, based on the further group specific resource configuration.

In some embodiments, the terminal device 110-1 may receive the configuration information via a RRC signaling.

In some embodiments, an apparatus capable of performing any of the method 700 (for example, the network device 120) may comprise means for performing the respective steps of the method 700. The means may be implemented in any suitable form. For example, the means may be implemented in a circuitry or software module.

In some embodiments, the apparatus comprises means for dividing a plurality of terminal devices into a plurality of groups based at least on channel characteristics associated with the plurality of terminal devices; means for determining, for a group of terminal devices among the plurality of groups, a beamforming weight associated with transmission of a downlink reference signal from the network device to the group of terminal devices; and means for transmitting, to a terminal device of the group of terminal devices, the downlink reference signal precoded by the beamforming weight.

In some embodiments, the means for dividing the plurality of terminal devices into the plurality of groups may comprise means for determining, for the plurality of groups, respective base terminal devices based on the channel characteristics associated with the plurality of terminal devices; and means for allocating a terminal device among the plurality of terminal devices other than the base terminal devices into one of the plurality of groups based on similarities between the channel characteristic associated with the terminal device and the channel characteristic associated with each of the base terminal devices.

In some embodiments, the means for determining the base terminal devices may comprise means for determining, for the plurality of terminal devices, respective channel representations of the channel characteristics associated with the plurality of terminal devices; means for determining channel similarities between any two of the plurality of terminal devices based on the channel representations; means for determining, among the plurality of terminal devices, a first terminal device and a second terminal device having a least channel similarity among the channel similarities and means for determining the first terminal device and the second terminal device as a base terminal device for a first group and a base terminal device for a second group among the plurality of groups, respectively.

In some embodiments, the means for determining the base terminal devices may further comprise means for determining, among the plurality of terminal devices other than the first and second terminal devices, a third terminal device and a fourth terminal device having a least channel similarity among the channel similarities; and means for determining the third terminal device and the fourth terminal device as a base terminal device for a third group and a base terminal device for a fourth group among the plurality of groups, respectively.

In some embodiments, the means for determining the base terminal devices may further comprise means for determining, based on the channel representations, respective maximum channel similarities for terminal devices among the plurality of terminal devices other than the first and second terminal devices, each of the maximum channel similarities being a greater one of a first channel similarity between a respective terminal device and the first terminal device and a second channel similarity between the respective terminal device and the second terminal device; means for determining, among the terminal devices other than the first and second terminal devices, a third terminal device having a minimum one among the maximum channel similarities; and means for determining the third terminal device as a base terminal device for a third group among the plurality of groups.

In some embodiments, the means for allocating the terminal device into one of the plurality of groups may comprise means for determining, among the base terminal devices, a base terminal device having a maximum channel similarity from the terminal device; and means for allocating, among the plurality of groups, the terminal device to a group, including the determined base terminal device.

In some embodiments, the means for determining the channel representations may comprise means for receiving an uplink reference signal from a terminal device among the plurality of terminal devices; means for determining, based on the received uplink reference signal, an uplink channel characteristic associated with the terminal device; and means for determining, based on the uplink channel characteristic, the channel representation associated with the terminal device.

In some embodiments, the means for determining the channel representations may comprise means for receiving, from the plurality of terminal devices, a plurality of respective channel state information reports; and means for determining the channel representations based on the plurality of channel state information reports.

In some embodiments, the apparatus may further comprise means for receiving, from the plurality of terminal devices, a plurality of respective uplink reference signals; and means for determining, based on the plurality of uplink reference signals, a plurality of uplink channel characteristics associated with the plurality of terminal devices.

In some embodiments, the means for determining the beamforming weight may comprise means for determining a sum uplink channel characteristic based on the plurality of uplink channel characteristics associated with the group of terminal devices; and means for determining the beamforming weight based on the sum uplink channel characteristic.

In some embodiments, the means for determining the beamforming weight based on the sum uplink channel characteristic may comprise means for determining a dominant eigenvector of the sum uplink channel characteristic as the beamforming weight.

In some embodiments, the means for determining the beamforming weight based on the sum uplink channel characteristic may comprise means for determining a GoB beam weight as the beamforming weight based on the sum uplink channel characteristic and predefined candidate GoB beams of the antenna array.

In some embodiments, the uplink channel characteristic associated with a terminal device among the plurality of terminal devices may be a covariance matrix for the terminal device averaged over subpanels and polarizations of an antenna array of the network device.

In some embodiments, the uplink channel characteristic associated with a terminal device among the plurality of terminal devices may be a covariance matrix for the terminal device averaged over polarizations of an antenna array of the network device.

In some embodiments, the apparatus may further comprise means for transmitting, to the terminal device of the group of terminal devices, configuration information indicating a group specific resource configuration for the downlink reference signal.

In some embodiments, the means for transmitting the downlink reference signal may comprise means for transmitting the downlink reference signal precoded by the beamforming weight based on the group specific resource configuration.

In some embodiments, the means for transmitting the configuration information may comprise means for transmitting the configuration information via at least one of a radio resource control (RRC) signaling, a medium access control (MAC) control element (CE), or downlink control information (DCI).

In some embodiments, the means for transmitting the configuration information may comprise means for transmitting, to the terminal device of the group of terminal devices, the configuration information indicating at least the group specific resource configuration and a further group specific resource configuration.

In some embodiments, the means for transmitting the downlink reference signal may comprise means for transmitting the downlink reference signal precoded by the beamforming weight based on the group specific resource configuration and means for transmitting the downlink reference signal precoded by a further beamforming weight based on the further group specific resource configuration. The further beamforming weight may be associated with transmission of a downlink reference signal from the network device to a further group of terminal devices among the plurality of groups. The further group of terminal devices may be different from the group of terminal devices.

In some embodiments, the means for transmitting the configuration information may comprise means for transmitting the configuration information via a RRC signaling.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 800 (for example, the terminal device 110-1) may comprise means for performing the respective steps of the method 800. The means may be implemented in any suitable form. For example, the means may be implemented in a circuitry or software module.

In some embodiments, the apparatus comprises: means for receiving, at a terminal device from a network device, configuration information indicating a group specific resource configuration for a downlink reference signal to be transmitted from the network device to a group of terminal devices including the terminal device; and means for receiving, from the network device, the downlink reference signal precoded by a beamforming weight associated with transmission of the downlink reference signal to the group of terminal devices, based on the group specific resource configuration.

In some embodiments, the means for receiving the configuration information may comprise means for receiving the configuration information via at least one of a radio resource control (RRC) signaling, a medium access control (MAC) control element (CE), or downlink control information (DCI).

In some embodiments, the means for receiving the configuration information may comprise means for receiving the configuration information indicating at least the group specific resource configuration and a further group specific resource configuration different from the group specific resource configuration.

In some embodiments, the apparatus may further comprise means for receiving, from the network device, the downlink reference signal precoded by a further beamforming weight associated with transmission of the downlink reference signal to a further group of terminal devices different from the group of terminal devices, based on the further group specific resource configuration.

In some embodiments, the means for receiving the configuration information may comprise means for receiving the configuration information via a RRC signaling.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

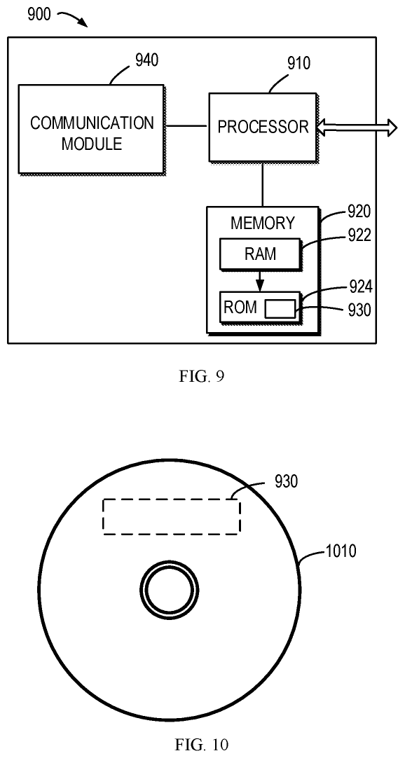

FIG. 9 is a simplified block diagram of a device 900 that is suitable for implementing embodiments of the present disclosure. The device 900 may be provided to implement the communication device, for example the terminal device 110-1 or the network device 120 as shown in FIG. 1. As shown, the device 900 includes one or more processors 910, one or more memories 920 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 1020. The processor 910 may perform any suitable actions and processing by loading the program 930 into the RAM 1020.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 900 as described above with reference to FIGS. 2-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A network device comprising:
at least one processor; and
at least one memory storing instructions that, when executed by the at least one processor, cause the network device at least to:
divide a plurality of terminal devices into a plurality of groups based at least on channel characteristics associated with the plurality of terminal devices;
determine, for a group of terminal devices among the plurality of groups, a beamforming weight associated with transmission of a downlink reference signal from the network device to the group of terminal devices; and
transmit, to a terminal device of the group of terminal devices, the downlink reference signal precoded by the beamforming weight.

2. The network device of claim 1, wherein the network device is caused to divide the plurality of terminal devices into the plurality of groups by:
determining, for the plurality of groups, respective base terminal devices based on the channel characteristics associated with the plurality of terminal devices; and
allocating a terminal device among the plurality of terminal devices other than the base terminal devices into one of the plurality of groups based on similarities between the channel characteristic associated with the terminal device and the channel characteristic associated with each of the base terminal devices.

3. The network device of claim 2, wherein the network device is caused to determine the base terminal devices by:
determining, for the plurality of terminal devices, respective channel representations of the channel characteristics associated with the plurality of terminal devices;
determining channel similarities between any two of the plurality of terminal devices based on the channel representations;
determining, among the plurality of terminal devices, a first terminal device and a second terminal device having a least channel similarity among the channel similarities; and
determining the first terminal device and the second terminal device as a base terminal device for a first group and a base terminal device for a second group among the plurality of groups, respectively.

4. The network device of claim 3, wherein the network device is caused to determine the base terminal devices further by:
determining, among the plurality of terminal devices other than the first and second terminal devices, a third terminal device and a fourth terminal device having a least channel similarity among the channel similarities; and
determining the third terminal device and the fourth terminal device as a base terminal device for a third group and a base terminal device for a fourth group among the plurality of groups, respectively.

5. The network device of claim 3, wherein the network device is caused to determine the base terminal devices further by:
determining, based on the channel representations, respective maximum channel similarities for terminal devices among the plurality of terminal devices other than the first and second terminal devices, each of the maximum channel similarities being a greater one of a first channel similarity between a respective terminal device and the first terminal device and a second channel similarity between the respective terminal device and the second terminal device;
determining, among the terminal devices other than the first and second terminal devices, a third terminal device having a minimum one among the maximum channel similarities; and
determining the third terminal device as a base terminal device for a third group among the plurality of groups.

6. The network device of claim 2, wherein the network device is caused to allocate the terminal device into one of the plurality of groups by:
determining, among the base terminal devices, a base terminal device having a maximum channel similarity from the terminal device; and
allocating, among the plurality of groups, the terminal device to a group, including the determined base terminal device.

7. The network device of claim 3, wherein the network device is caused to determine the channel representations by:
receiving an uplink reference signal from a terminal device among the plurality of terminal devices;
determining, based on the received uplink reference signal, an uplink channel characteristic associated with the terminal device; and
determining, based on the uplink channel characteristic, the channel representation associated with the terminal device.

8. The network device of claim 3, wherein the network device is caused to determine the channel representations by:
receiving, from the plurality of terminal devices, a plurality of respective channel state information reports; and
determining the channel representations based on the plurality of channel state information reports.

9. The network device of claim 1, wherein the network device is further caused to:
receive, from the plurality of terminal devices, a plurality of respective uplink reference signals; and
determine, based on the plurality of uplink reference signals, a plurality of uplink channel characteristics associated with the plurality of terminal devices.

10. The network device of claim 9, wherein the network device is caused to determine the beamforming weight by:
determining a sum uplink channel characteristic based on the plurality of uplink channel characteristics associated with the group of terminal devices; and
determining the beamforming weight based on the sum uplink channel characteristic.

11. The network device of claim 10, wherein the network device is caused to determine the beamforming weight based on the sum uplink channel characteristic by:
determining a dominant eigenvector of the sum uplink channel characteristic as the beamforming weight.

12. The network device of claim 10, wherein the network device is caused to determine the beamforming weight based on the sum uplink channel characteristic by:
determining a GoB beam weight as the beamforming weight based on the sum uplink channel characteristic and predefined candidate GoB beams of the antenna array.

13. The network device of claim 7, wherein the uplink channel characteristic associated with a terminal device among the plurality of terminal devices is a covariance matrix for the terminal device averaged over subpanels and polarizations of an antenna array of the network device.

14. The network device of claim 7, wherein the uplink channel characteristic associated with a terminal device among the plurality of terminal devices is a covariance matrix for the terminal device averaged over polarizations of an antenna array of the network device.

15. The network device of claim 1, wherein the network device is further caused to:
transmit, to the terminal device of the group of terminal devices, configuration information indicating a group specific resource configuration for the downlink reference signal.

16. The network device of claim 15, wherein the network device is caused to transmit the downlink reference signal by:
transmitting the downlink reference signal precoded by the beamforming weight based on the group specific resource configuration.

17. (canceled)

18. The network device of claim 15, wherein the network device is caused to transmit the configuration information by:
transmitting, to the terminal device of the group of terminal devices, the configuration information indicating at least the group specific resource configuration and a further group specific resource configuration.

19. The network device of claim 18, wherein the network device is caused to transmit the downlink reference signal by:
transmitting the downlink reference signal precoded by the beamforming weight based on the group specific resource configuration; and
transmitting the downlink reference signal precoded by a further beamforming weight based on the further group specific resource configuration, the further beamforming weight being associated with transmission of a downlink reference signal from the network device to a further group of terminal devices among the plurality of groups, the further group of terminal devices being different from the group of terminal devices.

20-25. (canceled)

26. A method comprising:
dividing, at a network device, a plurality of terminal devices into a plurality of groups based at least on channel characteristics associated with the plurality of terminal devices;
determining, for a group of terminal devices among the plurality of groups, a beamforming weight associated with transmission of a downlink reference signal from the network device to the group of terminal devices; and
transmitting, to a terminal device of the group of terminal devices, the downlink reference signal precoded by the beamforming weight.

27-29. (canceled)

30. A computer readable medium comprising program instructions that, when executed by an apparatus, cause the apparatus to perform at least the method of claim 26.
